(19) United States
(12) Patent Application Publication
(10) Pub. No.: US 2014/0189255 A1
(43) Pub. Date: Jul. 3, 2014

(54) METHOD AND APPARATUS TO SHARE MODIFIED DATA WITHOUT WRITE-BACK IN A SHARED-MEMORY MANY-CORE SYSTEM

(71) Applicants: Ramacharan Sundararaman, Santa Clara, CA (US); John C. Mejia, Santa Clara, CA (US); Oscar M. Rosell, Santa Clara, CA (US); Antonio Juan, Santa Clara, CA (US); Ramon Matas, Santa Clara, CA (US)

(72) Inventors: Ramacharan Sundararaman, Santa Clara, CA (US); John C. Mejia, Santa Clara, CA (US); Oscar M. Rosell, Santa Clara, CA (US); Antonio Juan, Santa Clara, CA (US); Ramon Matas, Santa Clara, CA (US)

(21) Appl. No.: 13/731,584

(22) Filed: Dec. 31, 2012

(51) Int. Cl. G06F 12/08

(52) U.S. Cl. CPC G06F 12/0828
USPC 711/146

(57) ABSTRACT

A cache-coherent device may include multiple caches and a cache coherency engine, which monitors whether there are more than one versions of a cache line stored in the caches and whether the version of the cache line in the caches is consistent with the version of the cache line stored in the memory.

### FIELD OF THE INVENTION

The present disclosure relates to cache coherent memory control, and in particular to data coherency management in a multi-core processor system with multiple core caches.

### DESCRIPTION OF RELATED ART

Modern general purpose processors may access main memory (for example, implemented as dynamic random access memory, or “DRAM”) through a hierarchy of one or more caches (e.g., L1 and L2 caches). Cache memories (for example, static random access memory, or “SRAM”, based) may return data more quickly, but may use more area and power.

Memory accesses by general purpose processors may display high temporal and spatial locality. Caches capitalize on this locality by fetching data from main memory in larger chunks than requested (spatial locality) and holding onto the data for a period of time even after the processor has used that data (temporal locality). This may allow requests to be served very rapidly from cache, rather than more slowly from DRAM. Caches also may satisfy a much higher read/write load (for higher throughput) than main memory, so previous accesses are less likely to be queued that might slow current accesses.

In a cache-coherent shared-memory many-core system, memory-write bandwidth is a precious resource. One core (“producer”) may produce some data that is consumed by multiple cores (“consumers”).

Some coherency protocols may have a request for ownership (RFO) from the producer that invalidates all other shared copies. Any reads by the consumers may cause the modified data be written back (write-back) to memory along with a copy of the modified data being provided to the requesting consumer core. This shares data that is consistent (clean) between the memory and the multiple caches. Multiple such write-backs may result in high memory-write bandwidth utilization.

Some coherency protocols may not allow quick sharing of dirty cache lines (data that may not be consistent with the version of the data in the memory) between caches, or they may not allow quick sharing of clean cache lines (data that may already be consistent with the version of the data in the memory) between caches.

Thus, there is a need to have a scalable cache-coherence protocol that does not waste memory bandwidth, to avoid unnecessary memory write-backs.

### DESCRIPTION OF THE FIGURES

Embodiments are illustrated by way of example and not limitation in the Figures of the accompanying drawings:

FIG. 1 illustrates a block diagram of a system according to an embodiment of the present disclosure.

FIG. 2 illustrates a state diagram of core cache states according to an embodiment of the present disclosure.

FIG. 3 illustrates a state diagram of global cache states according to an embodiment of the present disclosure.

FIG. 4 illustrates a method according to an embodiment of the present disclosure.

### DETAILED DESCRIPTION

The following description describes a method, a device, and a system of cache coherency within or in association with a processor, computer system, or other processing apparatus. In the following description, numerous specific details such as processing logic, processor types, micro-architectural conditions, events, enablement mechanisms, and the like are set forth in order to provide a more thorough understanding of embodiments of the present disclosure. It will be appreciated, however, by one skilled in the art that the invention may be practiced without such specific details. Additionally, some well known structures, circuits, and the like have not been shown in detail to avoid unnecessarily obscuring embodiments of the present disclosure.

A cache-coherent device may include multiple caches and a cache coherency engine, which monitors whether there are more than one versions of a cache line stored in the caches and whether the versions of the cache line in the caches is consistent with the version of the cache line stored in the memory.

A cache-coherent system may include multiple processors, multiple caches, and a cache coherency engine, which monitors whether there are more than one versions of a cache line stored in the caches and whether the versions of the cache line in the caches is consistent with the version of the cache line stored in the memory.

A method may include monitoring whether there are more than one versions of a cache line stored in the caches and whether the versions of the cache line in the caches is consistent with the version of the cache line stored in the memory.

Although the following embodiments are described with reference to a processor, other embodiments are applicable to other types of integrated circuits and logic devices. Similar techniques and teachings of embodiments of the present disclosure can be applied to other types of circuits or semiconductor devices that can benefit from higher pipeline throughput and improved performance. The teachings of embodiments of the present disclosure are applicable to any processor or machine that performs data manipulations. However, the present disclosure is not limited to processors or machines that perform 1024 bit, 512 bit, 256 bit, 128 bit, 64 bit, 32 bit, or 16 bit data operations and can be applied to any processor and machine in which manipulation or management of data is performed.

Although the below examples describe instruction handling and distribution in the context of execution units and logic circuits, other embodiments of the present disclosure can be accomplished by way of a data or instructions stored on a machine-readable, tangible medium, which when performed by a machine cause the machine to perform functions consistent with at least one embodiment of the invention. In one embodiment, functions associated with embodiments of the present disclosure are embodied in machine-executable instructions. The instructions can be used to cause a general-purpose or special-purpose processor that is programmed with the instructions to perform the operation of the present disclosure. Embodiments of the present disclosure may be provided as a computer program product or software which may include a machine or computer-readable medium having stored thereon instructions which may be used to program a computer (or other electronic devices) to perform one or more operations according to embodiments of the present disclosure. Alternatively, steps of embodiments of the present disclosure might be performed by specific hardware components that contain fixed-function logic for performing the steps, or by any combination of programmed computer components and fixed-function hardware components.

Instructions used to program logic to perform embodiments of the invention can be stored within a memory in the system, such as DRAM, cache, flash memory, or other storage. Furthermore, the instructions can be distributed via a network or by way of other computer readable media. Thus a machine-readable medium may include any mechanism for storing or transmitting information in a form readable by a machine (e.g., a computer), but is not limited to, floppy diskettes, optical disks, Compact Disc, Read-Only Memory (CD-ROMs), and magneto-optical disks, Read-Only Memory (ROMs), Random Access Memory (RAM), Erasable Programmable Read-Only Memory (EPROM), Electrically Erasable Programmable Read-Only Memory (EEPROM), magnetic or optical cards, flash memory, or a tangible, machine-readable storage used in the transmission of information over the Internet via electrical, optical, acoustical or other forms of propagated signals (e.g., carrier waves, infrared signals, digital signals, etc.). Accordingly, the computer-readable medium includes any type of tangible machine-readable medium suitable for storing or transmitting electronic instructions or information in a form readable by a machine (e.g., a computer).

A design may go through various stages, from creation to simulation to fabrication. Data representing a design may represent the design in a number of manners. First, as is useful in simulations, the hardware may be represented using a hardware description language or another functional description language. Additionally, a circuit level model with logic and/or transistor gates may be produced at some stages of the design process. Furthermore, most designs, at some stage, reach a level of data representing the physical placement of various devices in the hardware model. In the case where conventional semiconductor fabrication techniques are used, the data representing the hardware model may be the data specifying the presence or absence of various features on different mask layers for masks used to produce the integrated circuit. In any representation of the design, the data may be stored in any form of a machine readable medium. A memory or a magnetic or optical storage such as a disc may be the machine readable medium to store information transmitted via optical or electrical wave modulated or otherwise generated to transmit such information. When an electrical carrier wave indicating or carrying the code or design is transmitted, to the extent that copying, buffering, or re-transmission of the electrical signal is performed, a new copy is made. Thus, a communication provider or a network provider may store on a tangible, machine-readable medium, at least temporarily, an article, such as information encoded into a carrier wave, embodying techniques of embodiments of the present disclosure.

Although not shown, it will be appreciated that one or more of the processor cores may be coupled to other resources, in particular, an interface (or interfaces) to external network devices. Such external media devices may be any media interface capable of transmitting and/or receiving network traffic data, such as framing/media access control (MAC) devices, e.g., for connecting to 10/100BaseT Ethernet, Gigabit Ethernet, Asynchronous Transfer Mode (ATM) or other types of networks, or interfaces for connecting to a switch fabric. For example, in one arrangement, one network device could be an Ethernet MAC device (connected to an Ethernet network) that transmits data to or receives data from the processor, and a second network device could be a switch fabric interface to support communications to and from a switch fabric. Other resources may include, for example, control status registers (CSRs), interfaces to other external memories, such as packet buffer and control memories, and scratch memory.

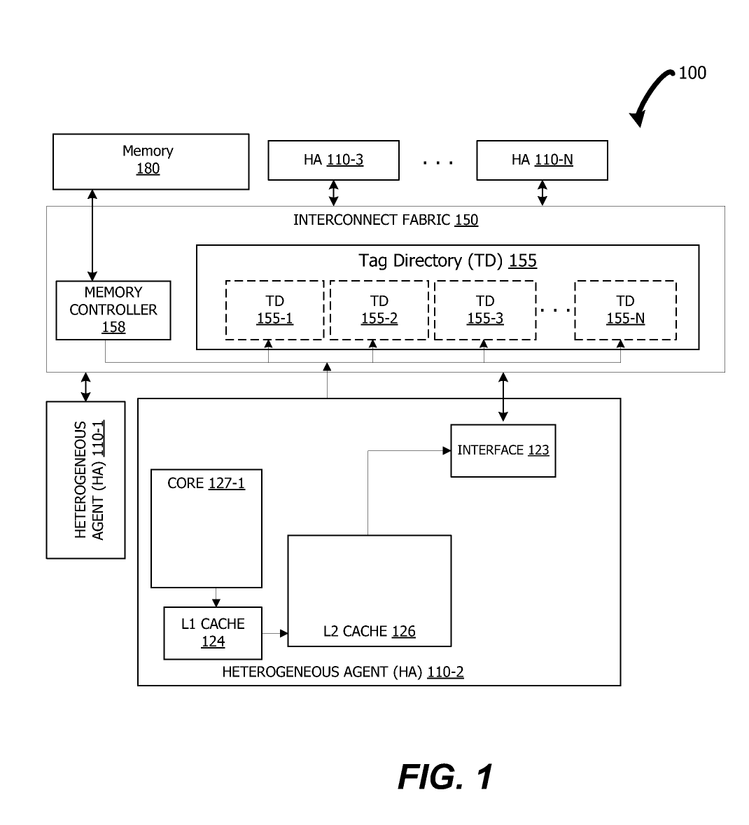

FIG. 1 illustrates a block diagram of a system according to an embodiment of the present disclosure.

The system 100 may include multiple processors (heterogeneous agents, HA110-1 to HA110-N), and multiple core caches (Level 1—L1 cache 124, Level 2—L2 cache 126, others not shown). The core caches may be located in the processors. Each processor may have a processor core (127-1) and an interface (123). The processors may be connected via their interfaces to an interconnect fabric (150). The interconnect fabric (150) may include a memory controller (158) and a tag directory (TD 155). The TD (155) may be one or more TD's (155-1 to 155-N) corresponding to the multiple processors, to monitor and track the status of cache lines in all of the caches in the multiple processors. Additionally, the interconnect fabric (150) may be connected to a memory (180) via the memory controller 158, as well as other additional devices, components, or processors (not shown). A cache coherency engine (not shown in detail) may be included in the processors or the interconnect fabric, to monitor the status of the cache lines.

The TD may act as a snoop filter/directory. The interconnect fabric may be an On-Die Interconnect (ODI). The TD may be centralized or distributed. According to an embodiment, the TD keeps track of the global state of all cache-lines in the system and the core caches that have copies of the cache-lines.

According to an embodiment of the present disclosure, each core cache may implement a cache coherency protocol with core (local) cache coherence states of M(odified), S(hared), E(xclusive), and I(nvalid), as shown in Table 1 below.

TABLE 1
Core Cache States

| Core Cache | |
|---|---|
| State | State Definition |
| M | Modified. Cache-line is updated relative to memory. |
| | Only one core may have a given line in M-state at |
| | a time. |
| E | Exclusive. Cache-line is consistent with memory. |
| | Only one core may have a given line in E-state at |
| | a time. |
| S | Shared. Cache-line is shared and consistent with |
| | other cores, but may not be consistent with memory. |
| | Multiple cores may have a given line in S-state at |
| | a time. |
| I | Invalid. Cache-line is not present in this core's |
| | L2 or L1. |

According to an embodiment of the present disclosure, the TD may have global (TD) states: “Globally Owned, Locally Shared” (GOLS) state, Globally Shared (GS), Globally Exclusive/Modified (GE/GM), and Globally Invalid (GI), as shown in Table 2 below.

TABLE 2
Tag Directory Coherence States

| TD State | State Definition |
|---|---|
| GOLS | Globally Owned, Locally Shared. Cache-line is present |
| | in one or more cores, but is not consistent with memory. |
| GS | Globally Shared. Cache-line is present in one or more |
| | cores and consistent with memory. |
| GE/GM | Globally Exclusive/Modified. Cache-line is owned by |
| | one and only one core and may or may not be consistent |
| | with memory. |
| GI | Globally Invalid. Cache-line is not present in any core. |

According to an embodiment of the present disclosure, the TD may not need to distinguish a local E state cache line from a local M state cache line, thus may have the combined GE/GM global state to track a cache line, to allow core cache lines to transition from E to M without informing the TD, and to allow cache line prefetching with ownership in the E state with intent to modify the cache line. The TD may not need to know whether the core has actually modified the line. The TD may send a snoop-probe to the owner core and determines the state based on the response. GS is the “clean shared” state (shared and consistent with memory) while GOLS is the “dirty shared” state (shared but modified/inconsistent from memory).

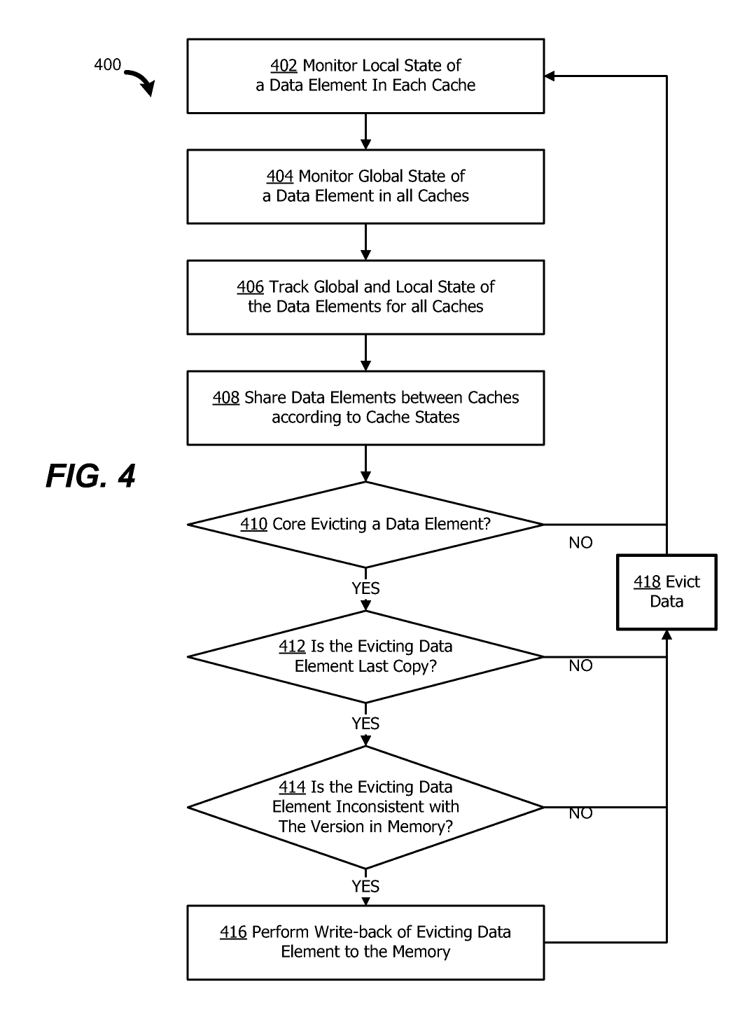

FIG. 4 illustrates a method according to an embodiment of the present disclosure.

The method 400 may be implemented in the system 100 to maintain cache coherency.

The process may start at block 402, the local cache states of cache lines (data elements) may be monitored in each core cache. The local cache states may be implemented according to a cache coherency protocol of an embodiment of the present disclosure.

The process continues at block 404, the global cache states of a data element may be monitored by the tag directory (TD 155). The global cache states may be implemented according to a cache coherency protocol of an embodiment of the present disclosure.

The process continues at block 406, the global and local cache states of a data element may be tracked. The global and local cache states may be recorded, stored, and updated as cache lines are requested or changed in the system. Historical statistics may be gathered for the global and local cache states as performance indicators, and to be used by the tag directory (TD 155) for adjusting protocol policies to optimize efficiencies of the caches in the system.

The process continues at block 408, where the core caches are controlled to allow sharing of data elements according to the global and local cache states of data elements. The system may determine according to the cache states that particular data elements may be sharable between the core caches. The system may determine whether particular data elements may be dirty shared or clean shared.

The process continues at block 410, the system determines if any core caches are evicting a data element. If there is no eviction, the process may return to block 402.

If there is an eviction, as determined in block 410, the process continues to block 412, the system determines if the eviction victim line (data element) the last copy in all the core caches. If the eviction victim line is not the last copy, the process may go to block 418.

If the eviction victim line is the last copy, the process continues at block 414, the system determines if the eviction victim line is inconsistent with the corresponding version of the victim line in the memory. If the eviction victim line is consistent with the version in the memory, the process may go to block 418.

If the eviction victim line is inconsistent with the version in the memory, the process continues at block 416, the system performs a write-back operation of the eviction victim to the memory.

The process continues at block 418, the system evicts the eviction victim from the core cache.

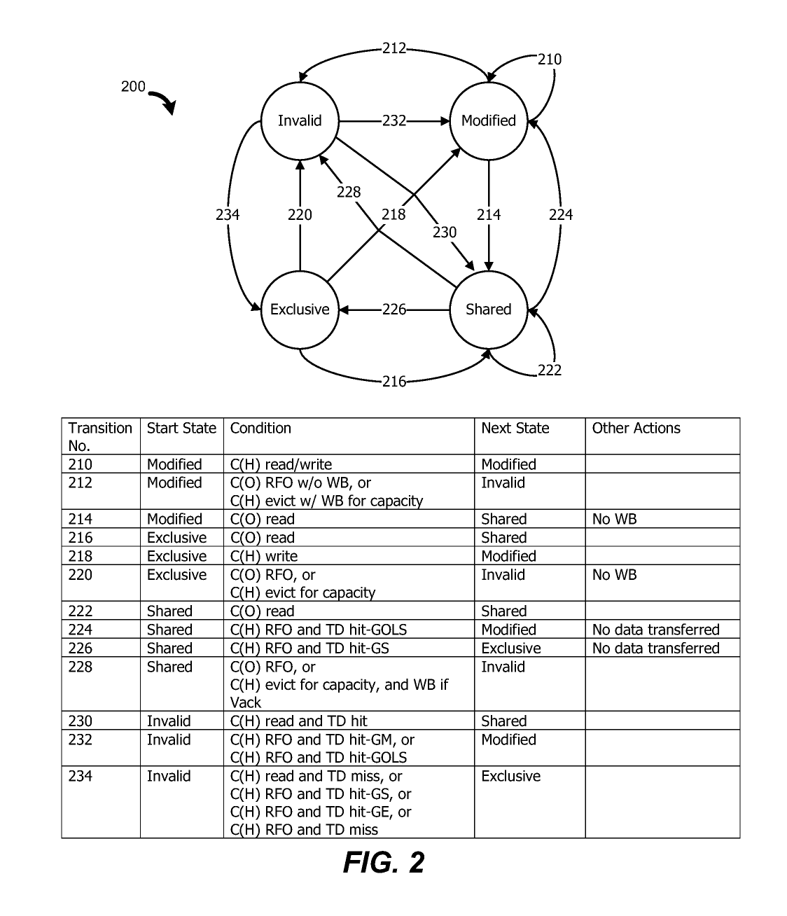

FIG. 2 illustrates a state diagram of core cache states 200 of an exemplary cache coherency protocol according to an embodiment of the present disclosure.

According to an embodiment of the present disclosure, FIG. 2 illustrates an exemplary state transition diagrams for core (local) cache states.

All cache misses or evictions may be notified to the TD for further determination. The TD responses may be:

Vack—Victim Ack (acknowledgment) for indicating that the victim line is the only copy of a dirty victim, and write-back is required.

Kack—Kill Ack (acknowledgment) for indicating that the victim line is a clean victim or is one of multiple dirty victim copies, and no write-back is required.

The TD 155 may provide responses based on the TD global states. If the cache line tag does not match any entry in TD, or the tag matches an entry with a state of GI, then the TD response is a TD-miss. If the cache line tag does not match any entry in TD, or the tag matches an entry with the state of GI, then TD response is a TD-miss. If the cache line tag matches an entry with a non-GI state, then TD response is a TD-hit.

Further, a TD-hit-GE means that the TD state was GE/GM and a snoop-probe to the core indicated that the state was exclusive (E). Similarly, a TD-hit-GM means that the TD state was GE/GM and a snoop-probe to the core indicated that the state was modified (M).

Transition 210 begins at start state Modified, upon the condition of a Home Core (C(H), or the core corresponding to the core cache storing the cache line) requesting a read or a write operation on the cache line, and ends at Modified.

Transition 212 begins at start state Modified, upon the condition of an Other Core (C(O), may indicate a core other than the C(H)) requesting a RFO without a write-back on the cache line, or with C(H) evicting the cache line with a write back to memory for additional cache capacity, and ends at Invalid.

Transition 214 begins at start state Modified, upon the condition of a core C(O) requesting a read, and ends at Shared, without write-back on the cache line.

Transition 216 begins at start state Exclusive, upon the condition of a core C(O) requesting a read on the cache line, and ends at Shared.

Transition 218 begins at start state Exclusive, upon the condition of a core C(H) requesting a write on the cache line, and ends at Modified.

Transition 220 begins at start state Exclusive, upon the condition of a core C(O) requesting a RFO on the cache line, or with core C(H) evicting the cache line for additional cache capacity, and ends at Invalid, without a write back to memory.

Transition 222 begins at start state Shared, upon the condition of a core C(O) requesting a read without write-back on the cache line, and ends at Shared.

Transition 224 begins at start state Shared, upon the condition of a core C(H) requesting a RFO on the cache line and the cache line hits in TD with a state of GOLS, and ends at Modified, with no data transferred.

Transition 226 begins at start state Shared, upon the condition of a core C(H) requesting a RFO on the cache line and the cache line hits in TD with a state of GS, and ends at Exclusive, with no data transferred.

Transition 228 begins at start state Shared, upon the condition of a core C(O) requesting a RFO on the cache line or with core C(H) evicting the cache line for additional cache capacity and performing a write-back if Vack is the response by TD, and ends at Invalid.

Transition 230 begins at start state Invalid, upon the condition of a core C(H) requesting a read on the cache line and results in a TD-hit, and ends at Shared.

Transition 232 begins at start state Invalid, upon the condition of a core C(H) requesting a RFO on the cache line and TD-hit-GM or GOLS, and ends at Modified.

Transition 234 begins at start state Invalid, upon the condition of a core C(H) requesting a read on the cache line and TD-miss, or core C(H) requesting a RFO and results in a TD-hit-GS, or core C(H) requesting a RFO and results in a TD-hit-GE, or core C(H) requesting a RFO and results in a TD-miss, and ends at Exclusive.

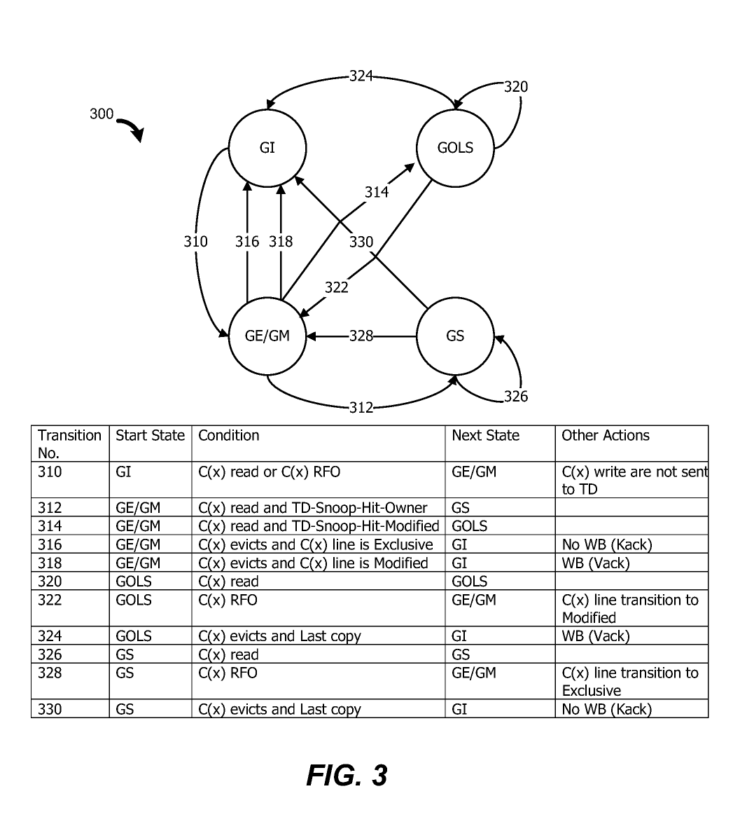

FIG. 3 illustrates a state diagram of global cache states 300 of an exemplary cache coherency protocol according to an embodiment of the present disclosure.

Initially, all cache-lines in the system start in GI. Write-hits in the core may not need to be notified to the TD.

Transition 310 begins at state GI, upon the condition of a request for Read/RFO from any core (C(x)), and ends at GE/GM.

Transition 312 begins at state GE/GM, upon the condition of a request for a read from core C(x), the TD sends a snoop-probe to the core that is the owner of this line. If it is a hit, the TD transitions to GS.

Transition 314 begins at state GE/GM, upon the condition of a request for a read from core C(x), the TD sends a snoop-probe to the core that is the owner of this line. If the response is a “hit-M,” which indicates the existence of the cache line in the core C(x) in the “Modified” state, the TD transitions to GOLS.

Transition 316 begins at state GE/GM, upon the condition of an eviction from core C(x) and the core state is E, ends at GI, with no write-back (Kack).

Transition 318 begins at state GE/GM, upon the condition of an eviction from core C(x) and the core state is M, ends at GI, with write-back (Vack).

Transition 320 begins at state GOLS, upon the condition of read for the cache line from core C(x), and ends at GOLS.

Transition 322 begins at state GOLS, upon the condition of RFO for the cache line from core C(x), and ends at GE/GM, with the C(x) core cache state transitioning to M.

Transition 324 begins at state GOLS, upon the condition of an eviction from C(x) and victim line is last copy, ends at GI, with write-back (Vack).

Transition 326 begins at state GS, upon the condition of read for the cache line from C(x), and ends at GS.

Transition 328 begins at state GS, upon the condition of RFO for the cache line from C(x), and ends at GE/GM, with the C(x) core cache state transitioning to E.

Transition 330 begins at state GS, upon the condition of an eviction from core C(x) and victim line is the last copy, ends at GI, with no write-back (Kack).

A “Hot-spot” or congestion may arise on the ODI in a system, when there are one producer core and multiple consumer cores, read requests from the consumers may need to be directed to a single core that may have modified the cache line without notification to the other caches.

The cache coherency protocol according to an embodiment of the present disclosure may prevent the “hot-spot” problem. Because any “GOLS” state copy of the cache line may be shared and forwarded to other core caches, as more reads come along, more “GOLS” state copies may be created in the core caches, and the coherency protocol may be optimized to determine which of the caches may be responsible for performing the next sharing/forwarding.

According to an embodiment of the present disclosure, a forwarding algorithm may randomize the forwarding core cache, by for example, using some physical-address bits as the starting point for a “find-first” search for a core in the list of cores that has this line. This may randomize the snoop traffic going to different cores for different addresses, and more evenly distribute traffic to avoid “hot-spots”.

According to an embodiment of the present disclosure, another forwarding algorithm may choose a forwarding core nearest to the requesting core, i.e. having the closest physical proximity between the cores, shortest data transmission delays, etc., to keep data traffic local to the requestor and forwarder core to prevent “hot-spots” and to provide a significant latency savings.

According to an embodiment of the present disclosure, some optimization algorithms may be based on the traffic pattern, by for example, allowing cores to forward data opportunistically when the core traffic is lower than a threshold or lower than other cores.

According to an embodiment of the present disclosure, the coherency protocol may include a local cache Forward (F) state that may allow cache line sharing between multiple readers and avoids the “hot-spot” issue by placing the last requestor of the cache line in the F state. The TD may track the core that has cache lines in the F state (with an encoded forwarder ID) to allow silently dropping/evicting S state cache lines from the cores without notifying the TD, as long as the F state cache line is notified to the TD. The TD states of GS and GOLS may continue to distinguish clean-sharing and dirty-sharing, and determine if the cache line data needs to be written back to the memory.

Furthermore, according to an embodiment of the present disclosure, the TD may not need to be a perfect snoop filter. An imperfect snoop-filter at the TD may be implemented with an F local cache state. The F state may be tracked in a core while the GOLS state allows dirty-sharing of cache lines. The TD with the imperfect snoop-filter may not need to track when the last cache line owner gives up/evicts the cache line. The local cache line in an F state evicting the cache line may indicate when to write back. Other copies in “S” state may be silently evicted. For example, below describes a scenario with two cores, C0 and C1:

C0 may have a cache line in M state.

C1 requests the cache line, and C1 may be in I state.

C0 receives a snoop to forward data. C0 goes to S and sends a “hit-M” response to the TD. The TD marks the line in GOLS state. The TD sends a “Globally-observed” response with state (GO_F) to C1. C1 transitions the cache line to F state.

Any subsequent requests to the cache line will be sourced by C1, as C1 was the last requestor of the cache line.

C1 may victimize the cache line. C1 sends VICTIM_F request. The TD receives VICTIM_F and sends a Vack to acknowledge that an F state cache line is being victimized for eviction. C1 writes back the dirty data to the memory.

Before C1 victimizes the cache line, C0 may silently victimize its line without informing the TD. The TD may send a snoop C0 sometimes and may need to handle a “miss” response.

Thus, the coherency protocol according to the embodiment of the present disclosure may allow dirty sharing, clean sharing and may avoid the “hot-spot” issue.

Other variations and modifications to the coherency protocol and algorithms are possible, and not limited to the examples given above.

Accordingly, unnecessary memory-write bandwidth may be reduced to provide better latency, without requiring additional states in the core caches, by using an unused state in the TD for tracking the global state of cache lines for cache sharing. This may allow cores to forward data to other cores to share clean or dirty cache lines, to additionally save memory-read bandwidth.

While certain exemplary embodiments have been described and shown in the accompanying drawings, it is to be understood that such embodiments are merely illustrative of and not restrictive on the broad invention, and that this invention not be limited to the specific constructions and arrangements shown and described, since various other modifications may occur to those ordinarily skilled in the art upon studying this disclosure. In an area of technology such as this, where growth is fast and further advancements are not easily foreseen, the disclosed embodiments may be readily modifiable in arrangement and detail as facilitated by enabling technological advancements without departing from the principles of the present disclosure or the scope of the accompanying claims.

What is claimed is:

1. A cache-coherent device, comprising:
a plurality of caches;
a cache coherency engine to monitor whether there are more than one versions of a data element stored in the plurality of the caches, and whether the more than one versions are consistent with a corresponding version of the data element in a memory coupled to the plurality of caches.

2. The device of claim 1, wherein the cache coherency engine is to determine that there are more than one versions of the data element in the plurality of the caches, and that the more than one versions are consistent with the corresponding version of the data element in the memory.

3. The device of claim 1, wherein the cache coherency engine determines that there are more than one versions of the data element in the plurality of the caches, and that the more than one versions are inconsistent with the corresponding version of the data element in the memory.

4. The device of claim 1, wherein the cache coherency engine determines that there is only one version of the data element in the plurality of the caches.

5. The device of claim 1, wherein the cache coherency engine determines that there is no version of the data element in the plurality of the caches.

6. The device of claim 1, wherein the cache coherency engine controls a write-back of the version of the data element from the plurality of the caches to the memory, in response to an eviction of the data element from the plurality of the caches, based on whether there are more than one versions of the data element stored in the plurality of the caches or whether the more than one versions of the data element are consistent with the corresponding version of the data element in the memory.

7. The device of claim 6, wherein the cache coherency engine controls the write-back of the version of the data element from the plurality of the caches to the memory, if there is only one version of the data element stored in the plurality of the caches, and if the only one version of the data element is inconsistent with the corresponding version of the data element in the memory.

8. A method for processing a transaction, comprising:
receiving a transaction request for a data element from one of a plurality of processor cores;
monitoring, by a cache coherency engine, whether there are more than one versions of a data element stored in a plurality of caches, and whether the more than one versions are consistent with a corresponding version of the data element in a memory.

9. The method of claim 8, wherein the cache coherency engine determines that there are more than one versions of the data element in the plurality of the caches, and that the more than one versions are consistent with the corresponding version of the data element in the memory.

10. The method of claim 8, wherein the cache coherency engine determines that there are more than one versions of the data element in the plurality of the caches, and that the more than one versions are inconsistent with the corresponding version of the data element in the memory.

11. The method of claim 8, wherein the cache coherency engine determines that there is only one version of the data element in the plurality of the caches.

12. The method of claim 8, wherein the cache coherency engine determines that there is no version of the data element in the plurality of the caches.

13. The method of claim 8, wherein the cache coherency engine controls a write-back of the version of the data element from the plurality of the caches to the memory, in response to an eviction of the data element from the plurality of the caches, based on whether there are more than one versions of the data element stored in the plurality of the caches or whether the more than one versions of the data element are consistent with the corresponding version of the data element in the memory.

14. The method of claim 13, wherein the cache coherency engine controls the write-back of the version of the data element from the plurality of the caches to the memory, if there is only one version of the data element stored in the plurality of the caches, and if the only one version of the data element is inconsistent with the corresponding version of the data element in the memory.

15. A processing system comprising:
a plurality of processor cores;
a plurality of caches; and
a cache coherency engine monitoring whether there are more than one versions of a data element stored in the plurality of the caches, and whether the more than one versions are consistent with a corresponding version of the data element in a memory.

16. The system of claim 15, wherein the cache coherency engine determines that there are more than one versions of the data element in the plurality of the caches, and that the more than one versions are consistent with the corresponding version of the data element in the memory.

17. The system of claim 15, wherein the cache coherency engine determines that there are more than one versions of the data element in the plurality of the caches, and that the more than one versions are inconsistent with the corresponding version of the data element in the memory.

18. The system of claim 15, wherein the cache coherency engine determines that there is only one version of the data element in the plurality of the caches.

19. The system of claim 15, wherein the cache coherency engine determines that there is no version of the data element in the plurality of the caches.

20. The system of claim 15, wherein the cache coherency engine controls a write-back of the version of the data element from the plurality of the caches to the memory, in response to an eviction of the data element from the plurality of the caches, if there is only one version of the data element stored in the plurality of the caches, and if the only one version of the data element is inconsistent with the corresponding version of the data element in the memory.
